(19) United States
(12) Patent Application Publication
(10) Pub. No.: US 2012/0015157 A1
(43) Pub. Date: Jan. 19, 2012

(54) DECORATION PLATE AND ELECTRONIC DEVICE USING THE SAME

(76) Inventors: Yen-Chu CHEN, Miaoli County (TW); Tzu-Chien Huang, Miaoli County (TW)

(21) Appl. No.: 13/173,921

(22) Filed: Jun. 30, 2011

(30) Foreign Application Priority Data
Jul. 13, 2010 (TW) 099122997

(51) Int. Cl. F21V 7/22; F21S 4/00; B32B 3/10

(52) U.S. Cl. 428/195.1; 362/249.01; 362/613

(57) ABSTRACT

A decoration plate and an electronic device using the same are provided. The decoration plate includes a structure layer and a light source layer. The structure layer has an inner surface and an outer surface and is provided with a plurality of prisms. The light source layer is formed on the inner surface side of the structure layer. The prisms are distributed to form a predetermined pattern. After entering into the structure layer from the light source layer, the light leaves the structure layer from the area covered by the predetermined pattern on the outer surface. Since the light is split into several beams with different exit angles, the area covered by the predetermined pattern will exhibit different visual effect from other area.

### BACKGROUND OF THE INVENTION

1. Field of the Invention

The present invention relates to a decoration plate and an electronic device using the same. In particular, the present invention relates to a decoration plate with colorful visual effect and an electronic device using the same.

2. Description of the Prior Art

With advance of technology, various electronic products are continuously promoted in specification and performance to allow the releasing speed of new products to become faster. However, as the current consumers' behavior is concerned, in addition to specification and performance, the appearance and recoginzability of product are also key considerations in purchase. Therefore, appearance design and recognizability enhancement are important items of product management.

FIG. 1A is a schematic view of the outer appearance of a traditional electronic product. Referring to FIG. 1A, a decoration plate 30 for brand identification is usually disposed on the outer shell of electronic product 10. Traditionally, the production process of the decoration plate 30 includes initially making a plaque unit 31 and then the plaque unit 31 is attached to the substrate 33 by adhesion, embedment, ultrasound or other methods to form the decoration plate 30 as shown in FIG. 1B. Moreover, the decoration plate 30 can made by printing, spray painting, electroplating, or vapor deposition, so that the decoration plate 30 can bear trademark, brand, or other identification graphics or symbols.

However, in the design mentioned above, the visual effect of the decoration plate 30 usually becomes monotonous. The identification text or graphic need to be highlighted often has only few colors in a single position or a fixed position, providing insignificant impression.

### SUMMARY OF THE INVENTION

It is an object of the present invention to provide a decoration plate with colorful visual effect and an electronic device using the same.

It is another object of the present invention to provide a highly distinguishable decoration plate and an electronic device using the same.

The decoration plate includes a structure layer and a light source layer. The structure layer has an inner surface and an outer surface and is provided with a plurality of prisms. The light source layer is formed on the inner surface side of the structure layer. Light from the light source layer enters into the structure layer from the inner surface of the structure layer, then is split by the prisms and emits from the structure layer. Since the light is split into several beams with different exit angles, the decoration plate can exhibit colorful or different visual effect. The prisms are distributed to form a predetermined pattern. The predetermined pattern may be various shapes, graphics, or character designs. After entering into the structure layer from the light source layer, the light leaves the structure layer from the area covered by the predetermined pattern on the outer surface to allow the predetermined area to show visual effect different from other area of the outer surface.

When the light source layer is a passive type, the light source layer includes a reflective material disposed corresponding to the inner surface of the structure layer. When the ambient light passes through the structure layer to the light source layer, the ambient light is reflected by the reflective material to the structure layer for showing the colorful visual effect or other visual effect. When the light source layer is an active type, the light source layer includes at least one active light source. Light from the active light source enters into the inner surface of the structure layer and then is split by the prisms to show the special visual effect.

### BRIEF DESCRIPTION OF THE DRAWINGS

FIG. 1A is a schematic view of the traditional decoration plate disposed on the electronic device;

FIG. 1B is a schematic view of the traditional decoration plate;

FIG. 2 is an exploded view of the decoration plate of the present invention ;

FIG. 3 is a cross-sectional view of an embodiment of the decoration plate;

FIGS. 4A, 4B, and 4C are schematic views of the prisms in different distribution patterns;

FIG. 5 is an embodiment with a transparent metal film;

FIG. 6 is an embodiment with a transparent cover layer;

FIG. 7 is another embodiment utilizing a reflective material;

FIG. 8 is an embodiment with an active light source;

FIG. 9A and 9B are embodiments with a base pattern layer;

FIG. 10 is an embodiment with a filling layer;

FIG. 11 is an embodiment with a filling layer and using a reflective material;

FIG. 12 is a schematic view of the electronic device including a decoration plate; and

FIG. 13 is an embodiment with a skew prism.

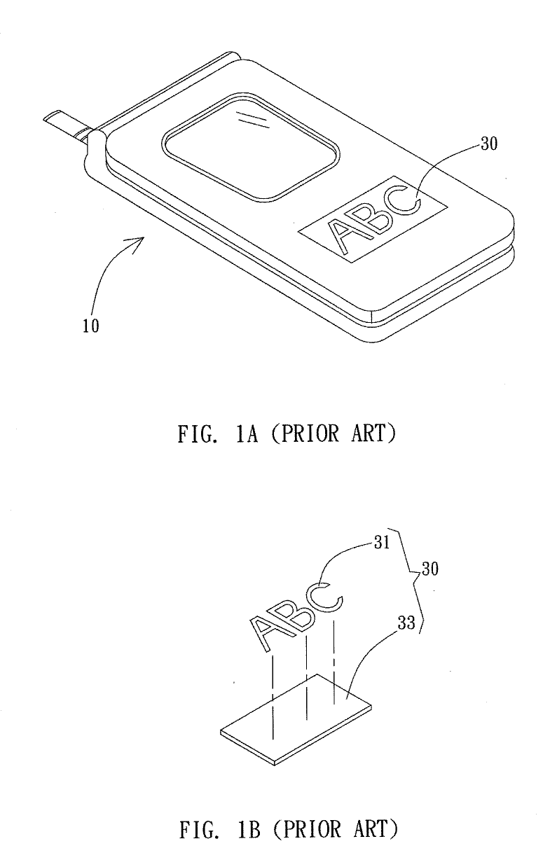

### DETAILED DESCRIPTION OF THE PREFERRED EMBODIMENT

The present invention relates to a decoration plate and an electronic device using the same. In a preferred embodiment, the decoration plate may be used in products as product marking, trademark, brand, identification text, or identification graphic. However, in other embodiments, the decoration plate may be ornamental to enhance the appearance of the electronic device and is not limited to specific texts or graphics. The electronic device mentioned above preferably includes portable electronic devices or home appliances such as flat panel display, personal computer, laptop computer, or mobile phone.

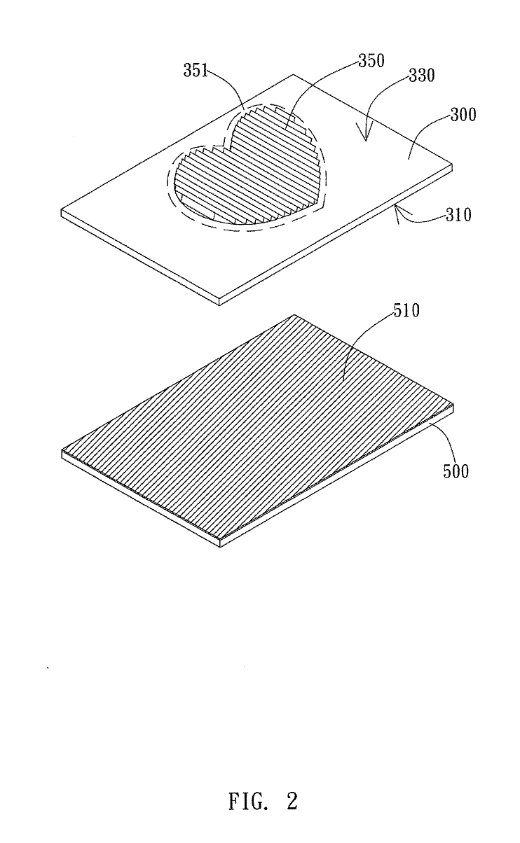

As shown in FIG. 2, the decoration plate includes a structure layer 300 and a light source layer 500. The structure layer 300 has an inner surface 310 and an outer surface 330, and is provided with a plurality of prisms 350. In this embodiment, the prisms 350 are distributed on the outer surface 330 of the structure layer 300 and protrude outward from the electronic device. The prisms 350 preferably include triangular prisms (prism with triangular cross-section); however, in different embodiments, the cross section of the prisms 350 may includes tetragon, pentagon, or triangle with curved surface. In addition, the prisms 350 are preferably arranged in parallel; however, in different embodiments, the prisms 350 may be arranged in concentric circles, a radiant pattern, or other ways. For increasing the light efficiency, the transmittance of the structure layer 300 is preferably between 0.2 μm and 25 μm.

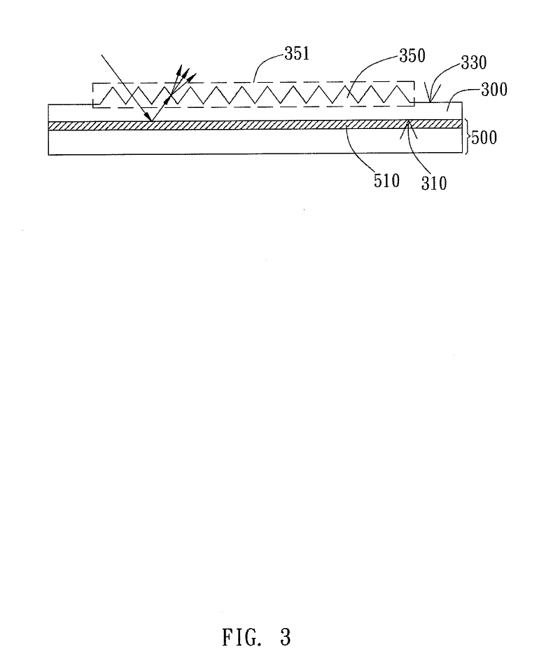

As shown in FIG. 2, the light source layer 500 is formed on the inner surface side 310 of the structure layer 300. Light generated from the light source layer 500 enters into the structure layer 300 from the inner surface 310 of the structure layer 300. After entering into the structure layer 300, light is then split by the prisms 350 and emits from the structure layer 300. Since the light is split into several beams with different exit angles, the decoration plate can exhibit colorful or different visual effect. In this embodiment, the light source layer 500 includes a reflective material 510 disposed corresponding to the inner surface of the structure layer 300. As shown in FIG. 3, when the ambient light passes through the structure layer 300 to the light source layer 500, the ambient light is reflected by the reflective material 510 to the structure layer 300 to provide the colorful visual effect or other visual effect. Besides, since the colorful visual effect mentioned above results from the splitting of light by the prisms 350, when viewing from different angles, the color performance of the decoration plate will accordingly change to provide various visual experiences.

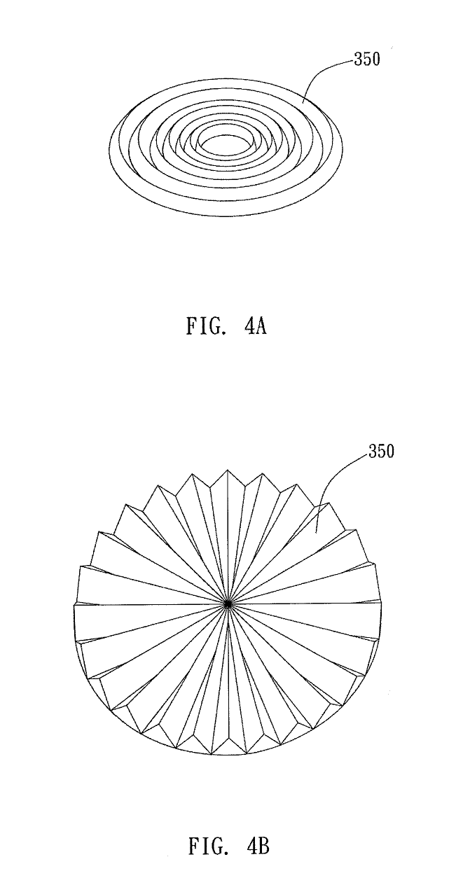

As shown in FIG. 2 and FIG. 3, the prisms 350 are distributed to form a predetermined pattern 351. In this embodiment, the predetermined pattern 351 is a heart pattern; however, in different embodiments, the predetermined pattern 351 may be other patterns, graphics, or character designs. After the light generated from the light source layer 500 enters into the structure layer 300, the light leaves the structure layer 300 from the area covered by the predetermined pattern 351 on the outer surface 330, to allow the area covered by the predetermined pattern 351 to exhibit different visual effect from other area of the outer surface 330. In addition to parallel arrangement, as shown in FIG. 4A to 4C, in coordinate with the predetermined pattern 351, the prisms 350 may be arranged in concentric circles, radiant pattern, or cross arrangement to achieve different visual effects.

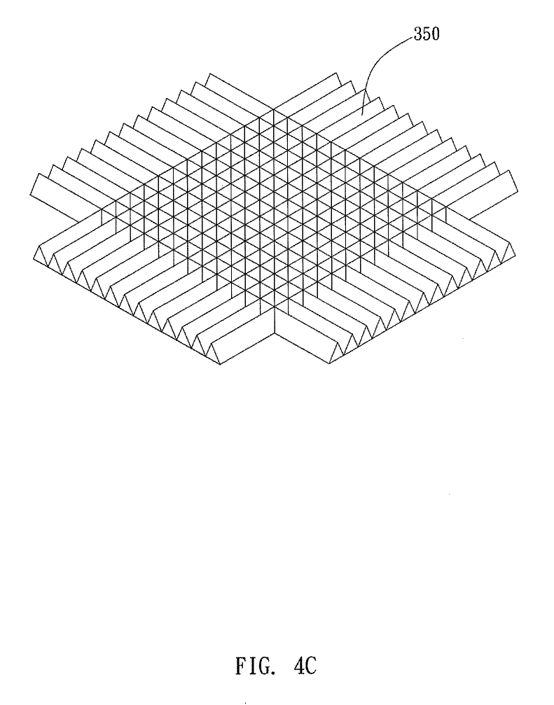

In the embodiment shown in FIG. 5, the decoration plate further includes a transparent metal film 710. The transparent metal film 710 is preferably a metal film formed on the outer surface 330 of the structure layer 300 by sputtering or other methods. Because of the thin thickness of the transparent metal film 710, the transparent metal film 710 is still transparent to allow light from the light source layer 500 into the structure layer 300 to be spilt by the prisms 350 and leave from the outer surface 330 of the structure layer 300. With the transparent metal film 710, the colorful visual effect will be further enhanced with metallic luster. As shown in FIG. 5, the transparent metal film 710 preferably covers the predetermined pattern 351. The outer surface of the transparent metal film 710 is parallel to the surfaces of the prisms 350. That is, the outer surface of the transparent metal film 710 is conformal to the surfaces of the prisms 350.

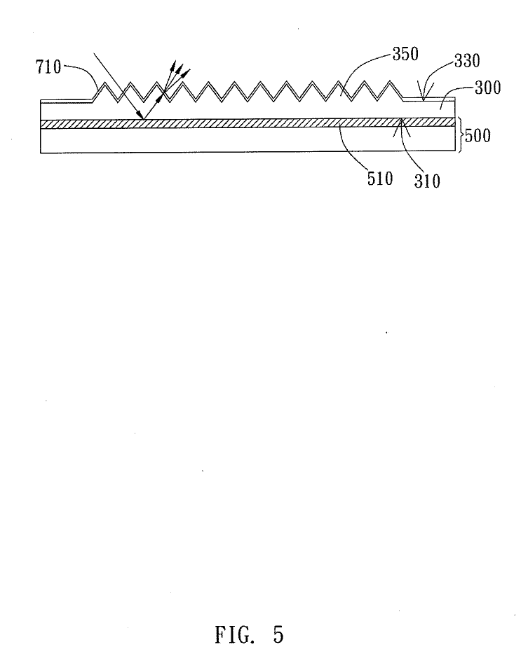

In the embodiment shown in FIG. 6, the decoration plate includes a transparent cover layer 730. The transparent cover layer 730 is coated on the outer surface 330 of the structure layer 300 and covers the predetermined pattern 351 and the rest of the outer surface 330. Comparing to the transparent metal film 710, the outer surface of the transparent cover layer 730 is a planarization surface and spans across at least some of the prisms 350. In addition, the transparent cover layer 730 is preferably made of transparent plastics and has a preset thickness. With the arrangement of the transparent cover layer 730 and in coordinate with its transmittance, the area covered by the predetermined pattern 351 on the outer surface 330 can exhibit visual effect of stereoscopic depth with respect to other area of the outer surface 330 of the structure layer 300.

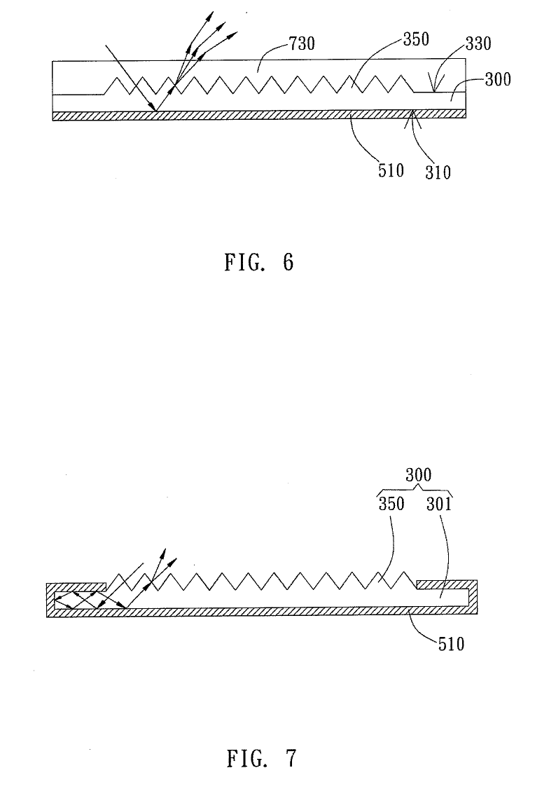

As shown in FIG. 7, the structure layer 300 includes a transparent substrate 301 and the prisms 350 are uniformly distributed on the substrate 301. In a preferred embodiment, the substrate 301 is made of transparent plastics; however, the substrate 301 may be made of glass, other clear or transparent materials. Since the prisms 350 preferably cover only a portion of the substrate 301, the end portions of the substrate 301 will extend beyond the area covered by the prisms 350. In this embodiment, the light source layer 500 includes a reflective material 510 covering the portion of the substrate 301 extending beyond the prisms 350. When the ambient light enters into the structure layer 300, the ambient light is then reflected by the reflective material 510. As shown in FIG. 7, a part of light will be reflected to the surface of the substrate 301 not covered by the prisms 350 and is immediately reflected by the reflective material 510 back to the substrate 301 for recycle, then leaves from the prisms 350. The light efficiency will be increased and the light leaking from the end portions of the substrate 301 will be decreased by disposing the reflective material 510 on the area of the substrate 301 that extends beyond the prisms 350.

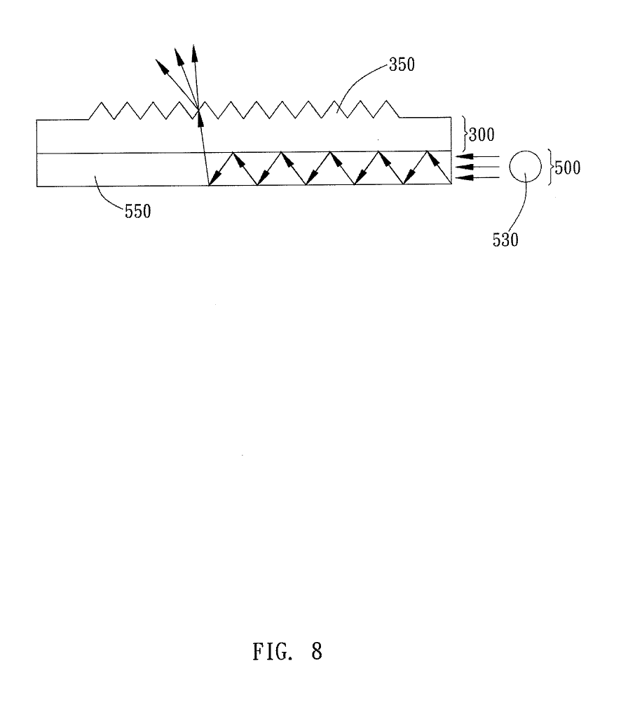

In the embodiment shown in FIG. 8, the light source layer 500 includes at least one active light source 530. In a preferred embodiment, the active light source 530 may be a light emitting diode, a cold cathode tube, or any light source that can receive electronic signal and actively generate light. As shown in FIG. 8, the light source layer 500 further includes light guide plate 550 disposed on the inner surface side 310 of the structure layer 300. The active light source 530 is disposed at one end of the light guide plate 550 and emits light toward the light guide plate 550. Light travels inside the light guide plate 550 and leaves from the light exit surface 551 of the light guide plate 550 to enter into the structure layer 300 from the inner surface 310. Light entering into the structure layer 300 is split into several beams by the prisms 350 to exhibit the special visual effect.

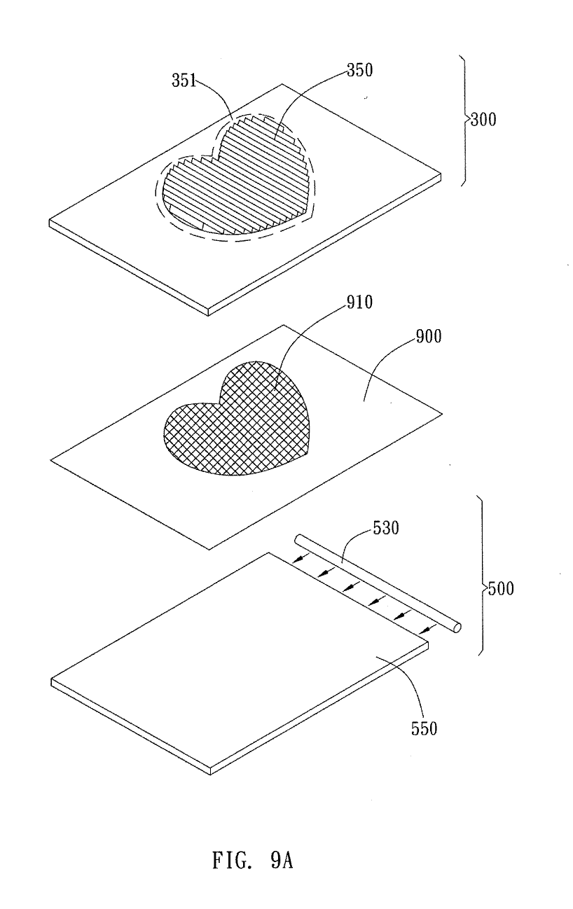

The decoration plate preferably further includes a base pattern layer 900, wherein a base pattern 910 is formed on the base pattern layer 900 and corresponds to the predetermined pattern 351 of the structure layer 300. In a preferred embodiment, the base pattern 910 and the predetermined pattern 351 are the same and their projection areas are congruent. However, in different embodiments, the base pattern 910 and the predetermined pattern 351 can be arranged in a staggered way or in a scaling way. As shown in FIG. 9A, if the light source layer 500 includes the active light source 530, the base pattern layer 900 is a light-transparent layer disposed between the light source layer 500 and the structure layer 300. The base pattern 910 is preferably light-transparent and has color different from other area of the base pattern layer 900. In different embodiments, the base pattern 910 may have alternatively arranged colors. Light from the active light source 530 passes through the base pattern 910 and is then incident to the area covered by the predetermined pattern 351 of the structure layer 300. With the base pattern layer 900, the versatility of color and visual effects of the decoration plate can be enhanced.

As shown in FIG. 9B, when the light source layer 500 is passive type and has a reflective material 510, the base pattern 900 is formed on the light source layer 500 and faces the inner surface 310 of the structure layer 300. Meanwhile, the base pattern 910 of the base pattern layer 900 consists of the reflective material 510 and reflects the ambient light to the area of the predetermined pattern 351 on the structure layer 300. Other area of the base pattern layer 900 may be opaque or non-reflective, or may be different from the base pattern 910 in color.

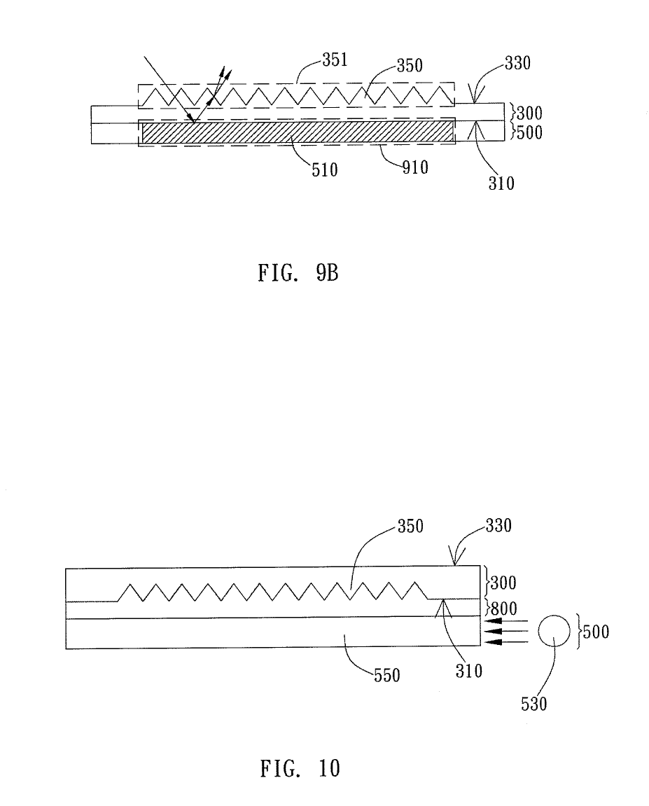

The embodiment as shown in FIG. 10, the prisms 350 are formed on the inner surface 310 of the structure layer 300. To maintain relative position between the prisms 350 and the light source layer 500 (active or passive) and to improve the light transmission effect between the structure layer 300 and the light source layer 500, or for other reasons, a filling layer 800 can be disposed between the prisms 350 and the light source layer 500. Preferably, the filling layer 800 is closely attached to the surfaces of the prisms 350 and is made of transparent material with transmittance between 0.2 μm and 25 μm to provide specific optic effect. In a preferred embodiment, the filling layer 800 is preferably made of transparent plastics; however, in a different embodiment, the filling layer 800 may made of other materials.

In the embodiment shown in FIG. 10, the prisms 350 are formed on the inner surface 310 of the structure layer 300; however, in another embodiment, the prisms 350 may be formed on the outer surface 330 of the structure layer 300. Meanwhile, the filling layer 800 is closely attached to the inner surface 310 of the structure layer 300 to provide better optical effect or enhance other structural characteristics.

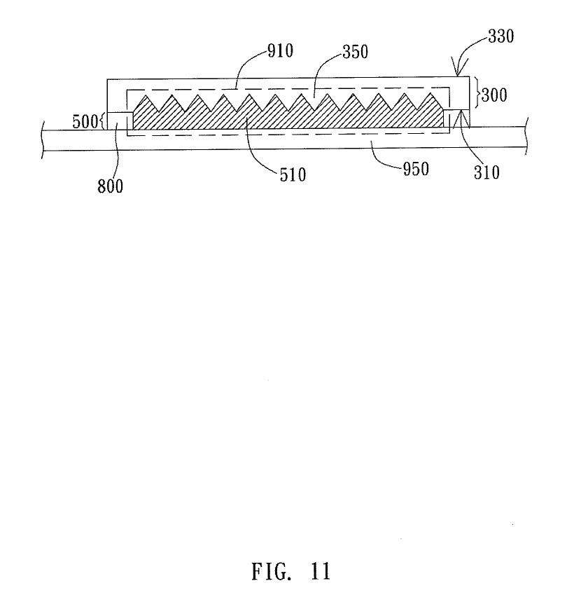

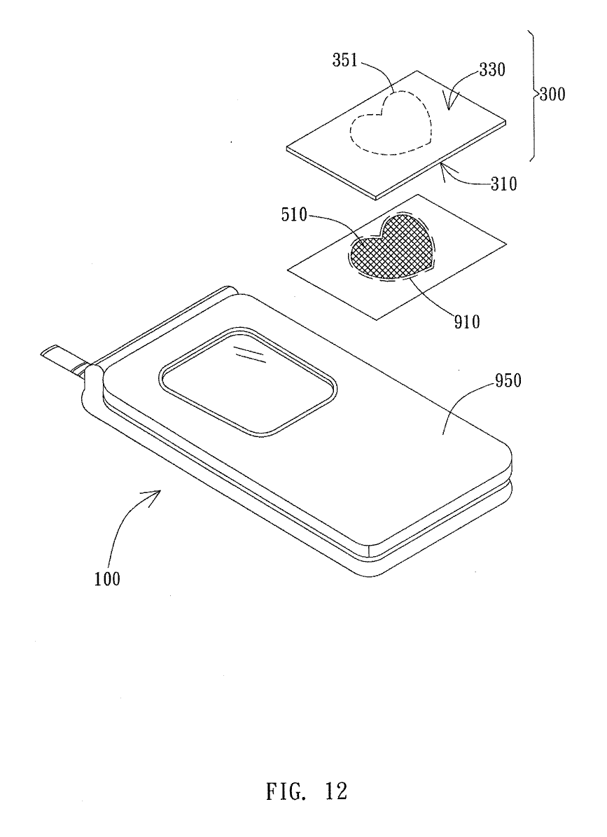

As shown in FIG. 11, when the prisms 350 are formed on the inner surface 310 of the structure layer 300 and the light source layer 500 is passive type, the reflective material 510 of the light source layer 500 is preferably attached to the surfaces of the prisms 350. In this embodiment, the reflective material 510 is melt into the filling layer 800, allowing the filling layer 800 to form the base pattern 910 and to be reflective at least in the position of the base pattern 910. In this embodiment, the decoration plate further includes a bottom plate 950. The bottom plate 950 is preferably a shell of the electronic device 100 as shown in FIG. 12. The filling layer 800 including the reflective material 510 is disposed between the prisms 350 and the bottom plate 950 to provide specific optic effect and additional structure support.

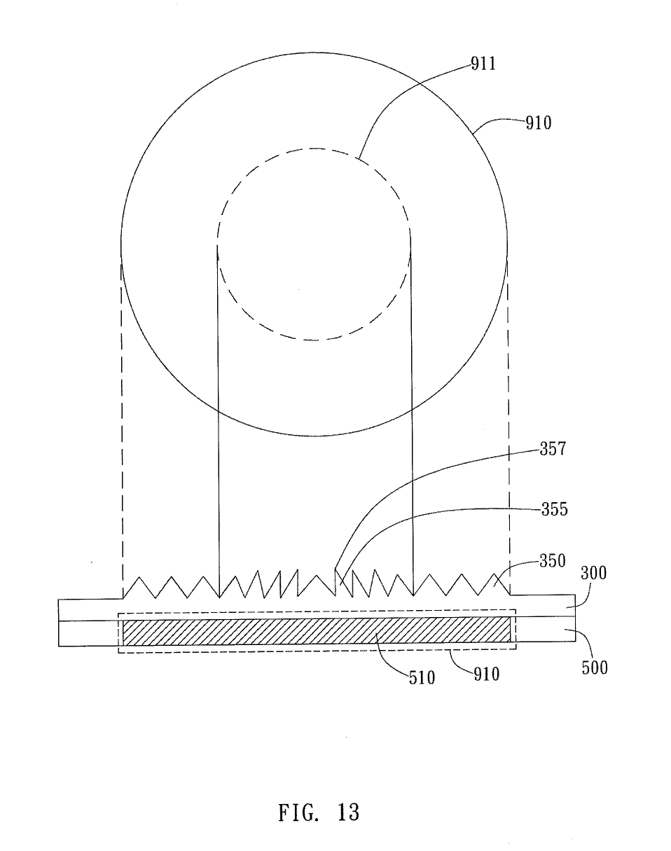

In the embodiment shown in FIG. 13, the prisms 350 disposed on the structure layer 300 include several skew prisms 355. In this embodiment, the skew prisms 355 have asymmetric sides to allow a ridge part 357 of the skew prisms 355 to incline toward one side. As shown in FIG. 13, when the base pattern 910 includes a stereoscopic area 911, the skew prisms 355 are disposed corresponding to the stereoscopic area 911. In this embodiment, the circular base pattern 910 includes the stereoscopic area 911 in the center part and the position of the skew prisms 355 overlaps with the projection of the stereoscopic area 911. As shown in FIG. 13, when the skew prisms 355 all incline toward the center of the stereoscopic area 911, the stereoscopic area 911 will provide a convex stereoscopic visual effect. When the skew prisms 355 all incline away from the center of the stereoscopic area 911, the stereoscopic area 911 will provide a concave stereoscopic visual effect.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A decoration plate for an electronic device, comprising:
a structure layer comprising a plurality of prisms disposed thereon and having an inner surface and an outer surface, wherein the prisms are distributed to form a predetermined pattern; and
a light source layer formed on the inner surface side of the structure layer, wherein light from the light source layer enters into the structure layer from the inner surface and leaves from an area covered by the predetermined pattern on the outer surface.

2. The decoration plate of claim 1, further comprising a transparent metal film, wherein the transparent metal film is coated on the outer surface of the structure layer and covers the predetermined pattern.

3. The decoration plate of claim 2, wherein the prisms are formed on the outer surface, an outer surface of the transparent metal film is parallel to surfaces of the prisms.

4. The decoration plate of the claim 1, wherein the light source layer comprises a reflective material for reflecting ambient light to provide the light.

5. The decoration plate of the claim 4, further comprising a base pattern layer formed on the light source layer to face the inner surface of the structure layer, wherein the base pattern layer is provided with a base pattern corresponding to the predetermined pattern, the base pattern reflects light to the area of the predetermined pattern.

6. The decoration plate of the claim 4, wherein the structure layer comprises a substrate and the prisms are disposed on the substrate, end portions of the substrate extend beyond the prisms and are covered by the reflective material.

7. The decoration plate of the claim 1, wherein the light source layer comprises at least one active light source, when a voltage is applied to the active light source, the active light source actively generates light to the structure layer.

8. The decoration plate of the claim 7, further comprising a base pattern layer formed between the light source layer and the inner surface of the structure layer, wherein a base pattern corresponding to the predetermined pattern is formed on the base pattern layer, light from the active light source passes through the base pattern incident onto the area of the predetermined pattern.

9. The decoration plate of the claim 7, further comprising a light guide plate disposed on the inner surface side of the structure layer, the active light source is disposed at one end of the light guide plate, wherein light from the active light source enters into the light guide plate and is transmitted by the light guide to the structure layer.

10. The decoration plate of the claim 1, further comprising a transparent cover layer coated on the outer surface of the structure layer, wherein the prisms are formed on the outer surface and covered by the transparent cover layer, an outer surface of the transparent cover layer is a planarization surface spanning across at least some of the prisms.

11. The decoration plate of the claim 1, further comprising a filling layer, wherein the prisms are formed on the inner surface of the structure layer, the filling layer is disposed between the structure layer and the light source layer.

12. The decoration plate of the claim 1, wherein the prisms are form on the inner surface of the structure layer, the light source layer comprises a reflective material attached onto surfaces of the prisms.

13. The decoration plate of the claim 12, further comprising a bottom plate disposed on one side of the light source layer opposite to the structure layer, wherein the reflective material is disposed between the structure layer and the bottom plate.

14. The decoration plate of the claim 5, wherein the prisms comprise a plurality of skew prisms, the base pattern comprises at least one stereoscopic area, the skew prisms are disposed corresponding to the stereoscopic area.

15. The decoration plate of the claim 8, wherein the prisms comprise a plurality of skew prisms, the base pattern comprises at least one stereoscopic area, the skew prisms are disposed corresponding to the stereoscopic area.
